(19) United States
(12) Patent Application Publication
(10) Pub. No.: US 2026/0066575 A1
(43) Pub. Date: Mar. 5, 2026

(54) Connector Assembly

(71) Applicant: Aptiv Technologies AG, Schaffhausen (CH)

(72) Inventors: Nicholas A. Durse, Youngstown, OH (US); Glenn Robison, Youngstown, OH (US); Michael Mellott, Youngstown, OH (US); William Lovitz, Niles, OH (US); Terry George, Salem, OH (US)

(21) Appl. No.: 19/276,391

(22) Filed: Jul. 22, 2025

Related U.S. Application Data
(60) Provisional application No. 63/688,936, filed on Aug. 30, 2024.

(51) Int. Cl. H01R 13/52; H01R 13/512; H01R 13/6581

(52) U.S. Cl. CPC H01R 13/5202; H01R 13/512; H01R 13/6581

(57) ABSTRACT

A device case for a connector assembly includes a header, a base, and a set of fasteners. The base includes a body portion and a wall extending from the body portion. The wall defines a sealing surface configured to engage a seal. The set of fasteners couples the header to the base. The set of fasteners is surrounded by the sealing surface.

### CROSS-REFERENCE TO RELATED APPLICATIONS

This application claims the benefit of U.S. Provisional Application No. 63/688,936 filed Aug. 30, 2024, the entire disclosure of which is incorporated by reference.

### FIELD

The present disclosure relates to a connector assembly and more particularly to connector assembly configured to directly connect to a device.

### BACKGROUND

Modern vehicles (e.g., automobiles) rely on electrical wiring and electrical connections to facilitate communication between various electronic components within the vehicle. Connection systems (e.g., connectors and terminals) play an important role in ensuring the integrity of these electrical connections and the reliability and performance of the vehicle. Some connector assemblies use a connector body with separate and/or external features and/or components (e.g., seals, bolts, etc.) for coupling with another connector and/or device. For example, some connector assemblies for high voltage applications use a header with a large flange for bolting to a device surface and provide separate sealing and shielding components as part of the assembly. The bolts and other hardware are often exposed to the environment and present challenges related to corrosion and sealing. While known connector assemblies for vehicle connection systems have proven acceptable for their intended purpose, a continuous need for improvement remains in the pertinent art to address the challenges associated with robust coupling of connectors relative to other connectors and devices.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

One aspect of the disclosure provides a device case for a connector assembly. The device case includes a header, a base, and a set of fasteners. The base includes a body portion and a wall extending from the body portion. The wall defines a sealing surface configured to engage a seal. The set of fasteners couples the header to the base. The set of fasteners is surrounded by the sealing surface.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1 is an exploded view of an example connector assembly according to the principles of the present disclosure.

FIG. 2 is a perspective view of an example connector housing for a connector assembly according to the principles of the present disclosure.

FIG. 3 is a perspective view of an example device case for a connector assembly according to the principles of the present disclosure.

FIG. 4 is a perspective view of the connector assembly of FIG. 1 in an assembled configuration.

FIG. 5 is a cross-sectional view of the connector assembly of FIG. 4 taken along the line 5-5 of FIG. 4.

FIG. 6 is a perspective view of another example connector assembly according to the principles of the present disclosure.

FIG. 7 is a perspective view of an example connector housing for a connector assembly according to the principles of the present disclosure.

FIG. 8 is a perspective view of an example device case for a connector assembly according to the principles of the present disclosure.

FIG. 9 is a perspective view of the connector assembly of FIG. 6 in an assembled configuration.

FIG. 10 is a cross-sectional view of the connector assembly of FIG. 9 taken along the line 10-10 of FIG. 9.

In the drawings, reference numbers may be reused to identify similar and/or identical elements.

### DETAILED DESCRIPTION

A direct contact technology (DCT) direct mate connector assembly may simplify connector assembly processes and reduce the number of required components. It may also lower the overall cost of the connector assembly and related systems by integrating features and components into the device case. Additionally, a DCT direct mate connector assembly may enhance corrosion resistance by incorporating elements such as fasteners and seals within the internal portions of the assembly, thereby minimizing exposure to environmental factors.

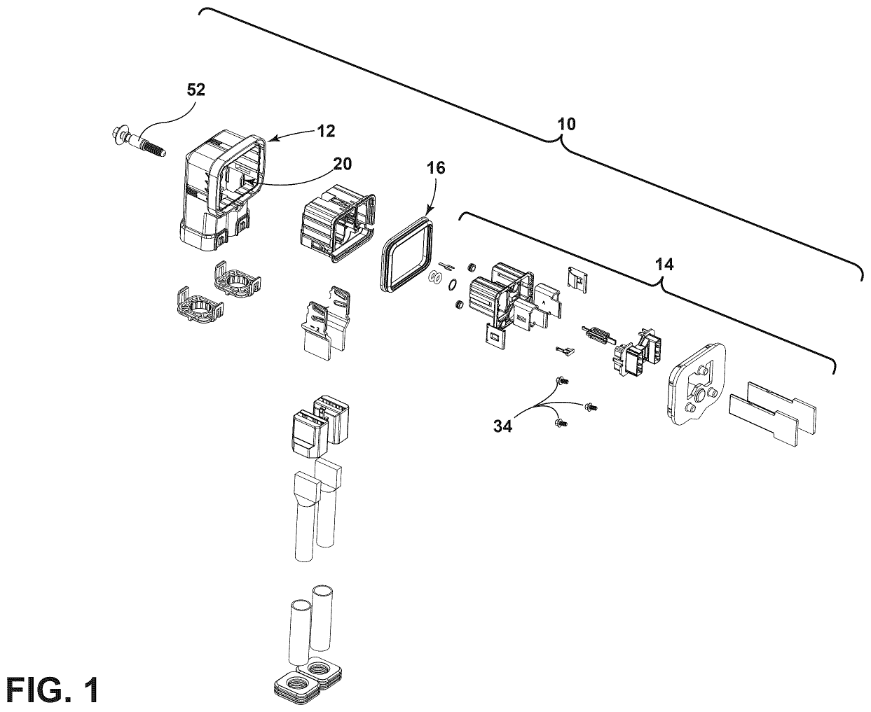

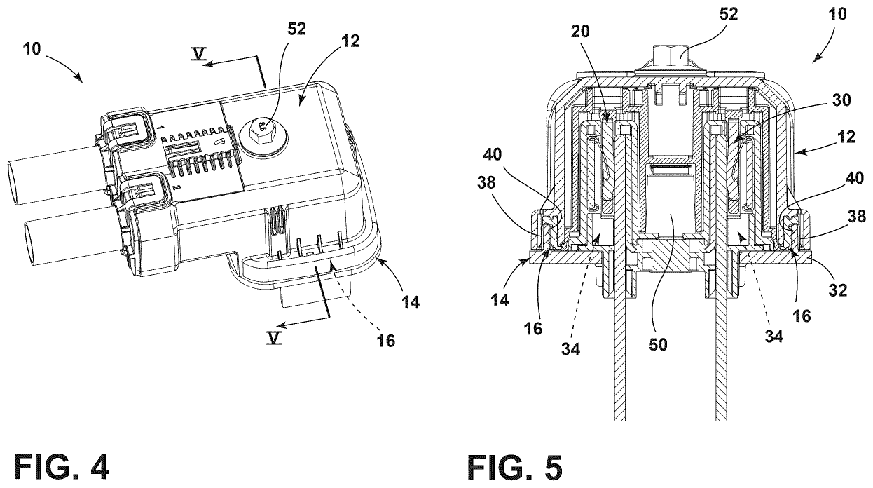

With reference to FIGS. 1 and 4, an example connector assembly 10 is shown. In various implementations, the assembly 10 includes a connector housing 12, a device case 14, and a seal 16, among others. The device case 14 may be detachably coupled to the housing 12.

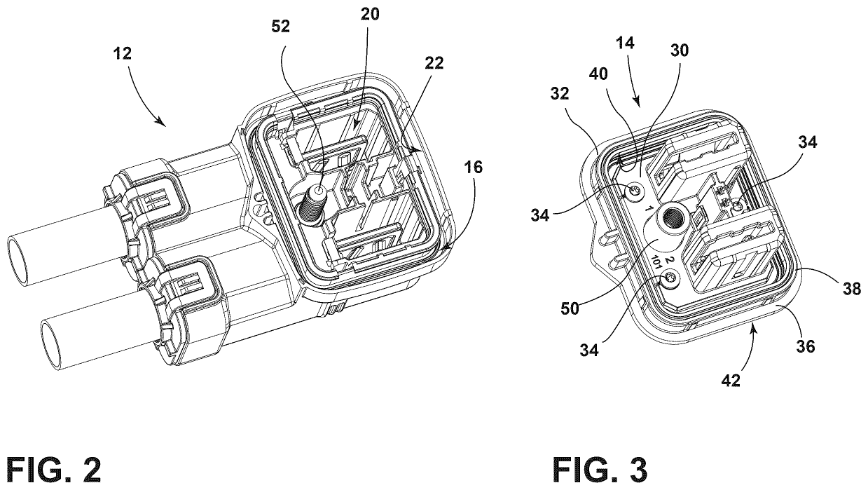

With reference to FIG. 2, in various implementations, the housing 12 defines a cavity 20. The cavity 20 may receive the device case 14 and the seal 16. The seal 16 may be coupled to the housing 12 and may surround the cavity 20. In various implementations, the seal 16 extends continuously and uninterrupted along a perimeter 22 of the cavity 20.

With reference to FIG. 3, an example device case 14 is shown. In various implementations, the device case 14 includes a header 30, a base 32, and a set of fasteners 34. In some example configurations, the base 32 includes a body portion 36 and a wall 38 extending from the body portion 36. The wall 38 may define a sealing surface 40. The sealing surface 40 may engage the seal 16.

In various implementations, the fasteners 34 couple the header 30 to the base 32. The fasteners 34 are surrounded by the sealing surface 40. In various implementations, the wall 38 extends continuously around a perimeter 42 of the base 32.

In various implementations, the device case 14 includes a threaded post 50. The threaded post 50 may extend from the base 32. In various implementations, the threaded post 50 receives a fastener 52 of the housing 12 to couple the device case 14 to the housing 12 (see, e.g., FIGS. 2 and 4). In various implementations, the sealing surface 40 surrounds the threaded post 50. In various implementations, the fasteners 34 are disposed about the threaded post 50.

With reference to FIG. 5, in an assembled configuration, the device case 14 is coupled to the housing 12 so that the seal 16 engages the sealing surface 40. The seal 16 inhibits fluid from contacting the fasteners 34. In various implementations, a portion of the fastener 52 is disposed in the cavity 20 and is surrounded by the seal 16.

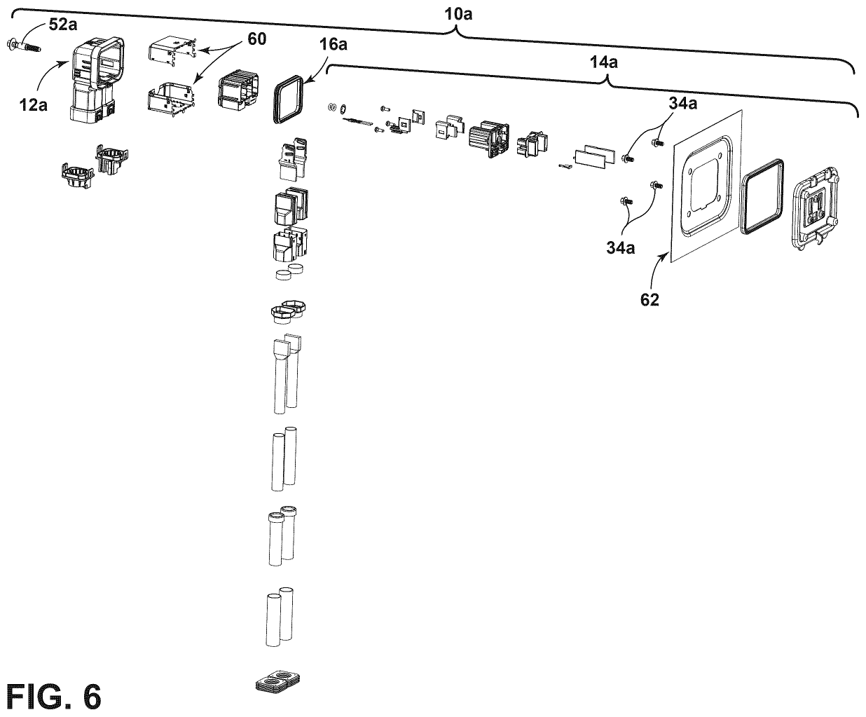

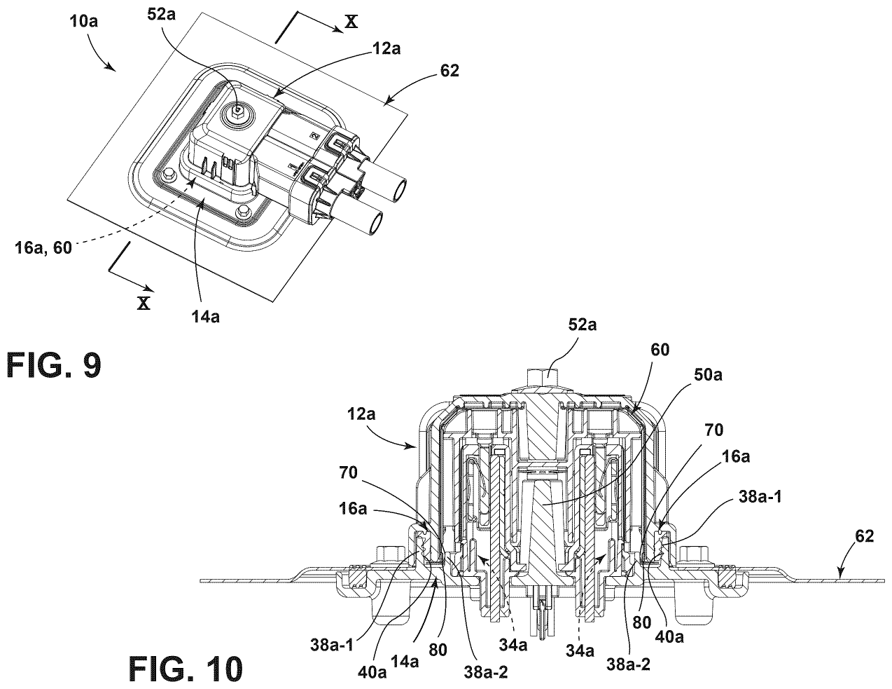

With reference to FIGS. 6 and 9, an example connector assembly 10a is shown. In view of the similarity in structure and function of the assembly 10a to the assembly 10, like reference numerals are used hereinafter and in the drawings to identify like components while like reference numerals containing letter extensions (e.g., “a”) are used to identify those components that have been modified.

In various implementations, the assembly 10a includes a connector housing 12a, a device case 14a, a seal 16a, an electromagnetic interference (EMI) shield 60, and/or a substrate 62, among others. The device case 14a may be detachably coupled to the housing 12a.

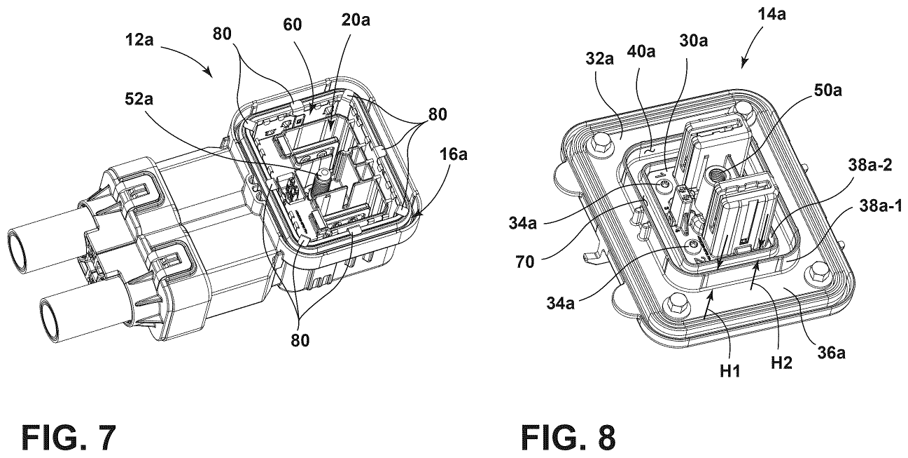

With reference to FIG. 7, in various implementations, the housing 12a defines a cavity 20a. The cavity 20a may receive the device case 14a, the seal 16a, and the shield 60. The seal 16a and/or the shield 60 may be coupled to the housing 12a and may surround the cavity 20a.

With reference to FIG. 8, in various implementations, the device case 14a includes a header 30a, a base 32a, and a set of fasteners 34a. In some example configurations, the base 32a includes a body portion 36a, a first wall 38a-1, and a second wall 38a-2 extending from the body portion 36a.

In various implementations, the first wall 38a-1 defines a sealing surface 40a. The sealing surface 40a may engage the seal 16a. The second wall 38a-2 may define an EMI shield surface 70. The shield surface 70 may engage the shield 60. In various implementation, the first wall 38a-1 defines a first height H1 and the second wall 38a-2 defines a second height H2. The second height H2 may be less than the first height H1.

In various implementations, the fasteners 34a couple the header 30a to the base 32a. The fasteners 34a are surrounded by the sealing surface 40a and the shield surface 70. In various implementations, the shield surface 70 surrounds the header 30a. In some example configurations, the shield surface 70 is offset from the sealing surface 40a. The shield surface 70 may be disposed inward of the sealing surface 40a.

In various implementations, the device case 14a includes a threaded post 50a. The threaded post 50a may extend from the base 32a. In various implementations, the threaded post 50a receives a fastener 52a of the housing 12a to couple the device case 14a to the housing 12a (see, e.g., FIGS. 7 and 9). In various implementations, the sealing surface 40a and the shield surface 70 surround the threaded post 50a. In various implementations, the fasteners 34a are disposed about the threaded post 50a.

Referring again to FIG. 7, in various implementations, the shield 60 includes a set of tabs 80. The tabs 80 may retain (e.g., engage) the seal 16a in an assembled configuration.

With reference to FIG. 10, in an assembled configuration, the device case 14a is coupled to the housing 12a so that the seal 16a engages the sealing surface 40a and the shield 60 engages the shield surface 70. The seal 16a inhibits fluid from contacting the fasteners 34a. The shield 60 may block or reduce electromagnetic interference to protect electronic components of the assembly 10a from signal disruption or malfunction. In various implementations, a portion of the fastener 52a is disposed in the cavity 20a and is surrounded by the seal 16a. The device case 14a may be coupled to the substrate 62.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. In the written description and claims, one or more steps within a method may be executed in a different order (or concurrently) without altering the principles of the present disclosure. Similarly, one or more instructions stored in a non-transitory computer-readable medium may be executed in a different order (or concurrently) without altering the principles of the present disclosure. Unless indicated otherwise, numbering or other labeling of instructions or method steps is done for convenient reference, not to indicate a fixed order.

Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

Spatial and functional relationships between elements (for example, between modules, circuit elements, semiconductor layers, etc.) are described using various terms, including “connected,” “engaged,” “coupled,” “adjacent,” “proximate,” “next to,” “on top of,” “above,” “below,” and “disposed. ” Unless explicitly described as being “direct,” when a relationship between first and second elements is described in the above disclosure, that relationship encompasses a direct relationship where no other intervening elements are present between the first and second elements as well as an indirect relationship where one or more intervening elements are present between the first and second elements. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The term “set” does not necessarily exclude the empty set—in other words, in some circumstances a “set” may have zero elements. The term “non-empty set” may be used to indicate exclusion of the empty set—in other words, a non-empty set will always have one or more elements. The term “subset” does not necessarily require a proper subset. In other words, a “subset” of a first set may be coextensive with (equal to) the first set. Further, the term “subset” does not necessarily exclude the empty set—in some circumstances a “subset” may have zero elements.

The terms first, second, third, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

The phrase “at least one of A, B, and C” should be construed to mean a logical (A OR B OR C), using a non-exclusive logical OR, and should not be construed to mean “at least one of A, at least one of B, and at least one of C. ” The phrase “at least one of A, B, or C” should be construed to mean a logical (A OR B OR C), using a non-exclusive logical OR.

The examples of the present disclosure may include one or more components such as connectors, terminals, conductors, insulating members, shielding structures, housings, retention features, and sealing elements, among others, as well as corresponding systems and assemblies. These examples may be configured to facilitate electrical signal transmission, power delivery, electromagnetic compatibility, or mechanical retention under various environmental conditions, such as thermal cycling, vibration, or exposure to fluids. Disclosed components, systems and assemblies, among others, may be arranged modularly or integrally to accommodate various system architectures and routing constraints.

Disclosed components may be fabricated from thermoplastics, thermoset resins, composites, or metals, optionally treated or coated for corrosion resistance, electromagnetic interference shielding, or biocompatibility for use in various applications, system, and environments, among others. In particular, in medical applications, sterilizable and/or biocompatible materials may be used. In solar or renewable energy systems, UV-resistant and/or weatherproof materials may be incorporated. In aerospace and space-based systems, weight reduction may be prioritized, and high-performance materials such as polyimide films, fluoropolymers, or ceramic composites may be employed.

Disclosed components, systems and assemblies, among others, may be designed for automated assembly, including robotic insertion, ultrasonic welding, or crimping techniques. Adaptations may be made to ensure compliance with relevant standards, including International Organization for Standardization, Military Specification, Society of Automotive Engineers, Food and Drug Administration, or International Electrotechnical Commission, depending on the target industry or market. In this regard, while examples and embodiments of the present disclosure may be illustrated and described herein in the context of an automobile, it will be appreciated that such examples and embodiments are equally suited for other applications, systems, environments, industries, and markets, among others. For example, implementations of the present disclosure that relate generally to electrical components and assemblies, and more particularly to connectors, terminals, wiring harnesses, and integrated electrical interconnection systems, among others, are suitable for a wide range of environments and applications.

While exemplary embodiments described herein may reference automotive use cases, the disclosed technology is not limited thereto and may be employed in any system requiring, for example, robust, secure, reliable, and/or durable electrical connectivity, among others. In particular, the structures, materials, and configurations disclosed may be adapted for use in aerospace systems, medical devices, consumer electronics, industrial automation, energy distribution networks, solar and other renewable energy installations, marine vessels, and space exploration platforms. Accordingly, although specific embodiments may describe automotive implementations, the principles disclosed herein are equally applicable to any system requiring robust electrical interconnection, and claims directed to any system, application, and/or environmental domain are, and will be, contemplated by one of skill in the art.

Various example embodiments of the invention are described in the following clauses.

Clause 1: A device case for a connector assembly, the device case comprising: a header; a base including a body portion and a wall extending from the body portion and defining a sealing surface configured to engage a seal; and a set of fasteners coupling the header to the base and surrounded by the sealing surface.

Clause 2: The device case of clause 1, wherein the wall extends continuously around a perimeter of the base.

Clause 3: The device case of clause 1 or 2, wherein the base includes an additional wall extending from the body portion and defining an electromagnetic interference (EMI) shield surface configured to engage an EMI shield.

Clause 4: The device case of clause 3, wherein the EMI shield surface surrounds the header.

Clause 5: The device case of clause 3, wherein the EMI shield surface is offset from the sealing surface.

Clause 6: The device case of clause 3, wherein the EMI shield surface is disposed inward of the sealing surface.

Clause 7: The device case of clause 3, wherein: the wall defines a first height, and the additional wall defines a second height that is less than the first height.

Clause 8: The device case of any of clauses 1 through 7, further comprising a threaded post extending from the base, wherein the threaded post is configured to receive a fastener of a connector to couple the device case to the connector.

Clause 9: The device case of clause 8, wherein the sealing surface surrounds the threaded post.

Clause 10: The device case of clause 8, wherein the set of fasteners is disposed about the threaded post.

Clause 11: A connector assembly comprising: a housing defining a cavity configured to receive the device case of any of clauses 1 through 10; and a seal coupled to the housing and surrounding the cavity, the seal configured to inhibit fluid from contacting the set of fasteners.

Clause 12: The connector assembly of clause 11, wherein the seal is configured to engage the sealing surface.

Clause 13: The connector assembly of clause 11 or 12, wherein the seal extends continuously and uninterrupted along a perimeter of the cavity.

Clause 14: The connector assembly of any of clauses 11 through 13, further comprising an electromagnetic interference (EMI) shield disposed within the cavity.

Clause 15: The connector assembly of clause 14, wherein the EMI shield is configured to engage an EMI shield surface of the device case.

Clause 16: The connector assembly of clause 14, wherein the EMI shield is disposed inward of the seal.

Clause 17: The connector assembly of clause 14, wherein: the EMI shield includes a set of tabs, and the set of tabs is configured to retain the seal.

Clause 18: The connector assembly of clause 14, wherein the EMI shield is configured to surround the header.

Clause 19: The connector assembly of any of clauses 11 through 18, further comprising a fastener, wherein a portion of the fastener is disposed in the cavity, and wherein the fastener is configured to be received by a threaded post to couple the device case to the housing.

Clause 20: The connector assembly of clause 19, wherein the seal is disposed about the fastener.

1. A device case for a connector assembly, the device case comprising:
a header;
a base including a body portion and a wall extending from the body portion and defining a sealing surface configured to engage a seal; and
a set of fasteners coupling the header to the base and surrounded by the sealing surface.

2. The device case of claim 1 wherein the wall extends continuously around a perimeter of the base.

3. The device case of claim 1 wherein the base includes an additional wall extending from the body portion and defining an electromagnetic interference (EMI) shield surface configured to engage an EMI shield.

4. The device case of claim 3 wherein the EMI shield surface surrounds the header.

5. The device case of claim 3 wherein the EMI shield surface is offset from the sealing surface.

6. The device case of claim 3 wherein the EMI shield surface is disposed inward of the sealing surface.

7. The device case of claim 3 wherein:
the wall defines a first height, and
the additional wall defines a second height that is less than the first height.

8. The device case of claim 1 further comprising a threaded post extending from the base,
wherein the threaded post is configured to receive a fastener of a connector to couple the device case to the connector.

9. The device case of claim 8 wherein the sealing surface surrounds the threaded post.

10. The device case of claim 8 wherein the set of fasteners is disposed about the threaded post.

11. A connector assembly comprising:
a housing defining a cavity configured to receive the device case of claim 1; and
a seal coupled to the housing and surrounding the cavity, the seal configured to inhibit fluid from contacting the set of fasteners.

12. The connector assembly of claim 11 wherein the seal is configured to engage the sealing surface.

13. The connector assembly of claim 11 wherein the seal extends continuously and uninterrupted along a perimeter of the cavity.

14. The connector assembly of claim 11 further comprising an electromagnetic interference (EMI) shield disposed within the cavity.

15. The connector assembly of claim 14 wherein the EMI shield is configured to engage an EMI shield surface of the device case.

16. The connector assembly of claim 14 wherein the EMI shield is disposed inward of the seal.

17. The connector assembly of claim 14 wherein:
the EMI shield includes a set of tabs, and
the set of tabs is configured to retain the seal.

18. The connector assembly of claim 14 wherein the EMI shield is configured to surround the header.

19. The connector assembly of claim 11 further comprising a fastener,
wherein a portion of the fastener is disposed in the cavity, and
wherein the fastener is configured to be received by a threaded post to couple the device case to the housing.

20. The connector assembly of claim 19 wherein the seal is disposed about the fastener.
